(19) United States
(12) Patent Application Publication
(10) Pub. No.: US 2020/0237067 A1
(43) Pub. Date: Jul. 30, 2020

(54) Modular Storage Case

(71) Applicant: Jimmylee Loc, Falls Church, VA (US)

(72) Inventor: Jimmylee Loc, Falls Church, VA (US)

(21) Appl. No.: 16/777,710

(22) Filed: Jan. 30, 2020

Related U.S. Application Data
(60) Provisional application No. 62/798,579, filed on Jan. 30, 2019.

(51) Int. Cl. A45C 13/02; B25H 3/02; A45C 13/00; A45C 5/03; A45C 5/06

(52) U.S. Cl. CPC A45C 13/02; B25H 3/023; A45C 5/06; A45C 5/03; A45C 13/001

(57) ABSTRACT

A modular storage case enabling a user to effectively store and deploy a variety of tools and expendable materials has a case body, a primary storage compartment, a first panel, a second panel, an offset hinge, at least one latch, and a base. The case body provides a rigid structure suitable for protecting the contents of the present invention. Accordingly, the primary storage compartment provides space within the case body including configurable structures for cargo retention. The first panel and the second panel define closures for the primary storage compartment linked by an offset hinge between the first and second panel, and a hinged fixation to the case body opposite the latch. In one configuration, a user may deploy the first and second panel into a cantilever wherein the second panel will engage to a base fixed to the case body to present a horizontal working surface.

The current application claims a priority to the U.S. Provisional Patent application Ser. No. 62/798,579 filed on Jan. 30, 2019.

### FIELD OF THE INVENTION

The present invention relates generally to the field of modular storage solutions. More specifically, the present invention provides a novel case construction featuring detachable and reconfigurable components, enabling a reasonably skilled user to reconfigure the present invention to serve a multitude of different functions as required.

### BACKGROUND OF THE INVENTION

To individuals in the construction and trades fields, transporting, organizing, and protecting all the tools that may be required for a job, including any necessary accessories or expendables, can pose a challenge even to exceptionally organized tradesmen. Carrying cases and bags available on the market presently can generally be expected to hold some of the larger tools generally required for standard jobs but fail to provide suitable retainers or compartmentalization to adequately contain many of the smaller items associated with those tools. Other cases provide substantial small-scale organizational structures but fail to provide a means of storing and supporting the larger tools previously mentioned. Further, the cases presently available on the market can generally be understood to facilitate the transport of materials to and from a site, as opposed to a deployable organizational tool in their own right.

The present invention aims to provide a unitized, modular solution to the shortcomings of presently available products in the construction field. In various reconfigurable forms, the present invention will provide a means to contain, support, organize, and protect an assortment of tools and miscellaneous items of any type, size, or description. The present invention will further support an on-site deployment configuration capable of supporting the organization of said materials in removeable compartments and on deployable work surfaces to be further outlined herein.

### BRIEF DESCRIPTION OF THE DRAWINGS

FIG. 1 is a perspective view of the present invention, wherein the present invention is illustrated in an open configuration.

FIG. 2 is an alternate perspective view of the present invention, wherein the present invention is illustrated in a closed configuration.

FIG. 3 is a perspective view of the present invention, wherein the present invention is illustrated in a deployed configuration.

FIG. 4 is a front elevational view of the present invention, wherein the present invention is illustrated in a deployed configuration.

FIG. 5 is a sectional view of the present invention taken along line 5-5 in FIG. 4, wherein the present invention is illustrated in a deployed configuration.

FIG. 6 is a detail view of area 6-6 in FIG. 5.

### DETAIL DESCRIPTIONS OF THE INVENTION

All illustrations of the drawings are for the purpose of describing selected versions of the present invention and are not intended to limit the scope of the present invention.

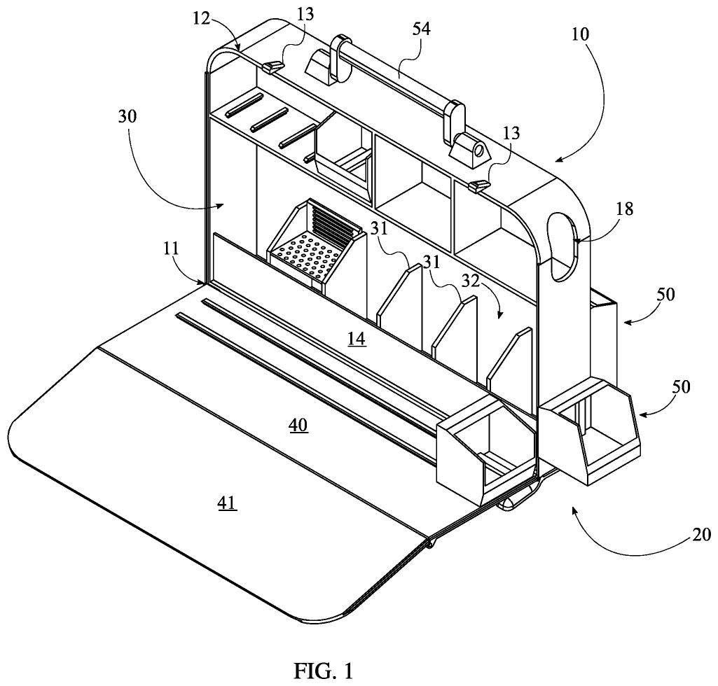

In reference to FIG. 1 through 6, the present invention is a modular storage case. The modular storage case aims to provide a unitized, modular solution to the shortcomings of presently available products in the construction field. In various reconfigurable forms, the modular storage case will provide a means to contain, support, organize, and protect an assortment of tools and miscellaneous items of any type, size, or description. The modular storage case will further support an on-site deployment configuration capable of supporting the organization of said materials in removeable compartments and on deployable work surfaces to be further outlined herein.

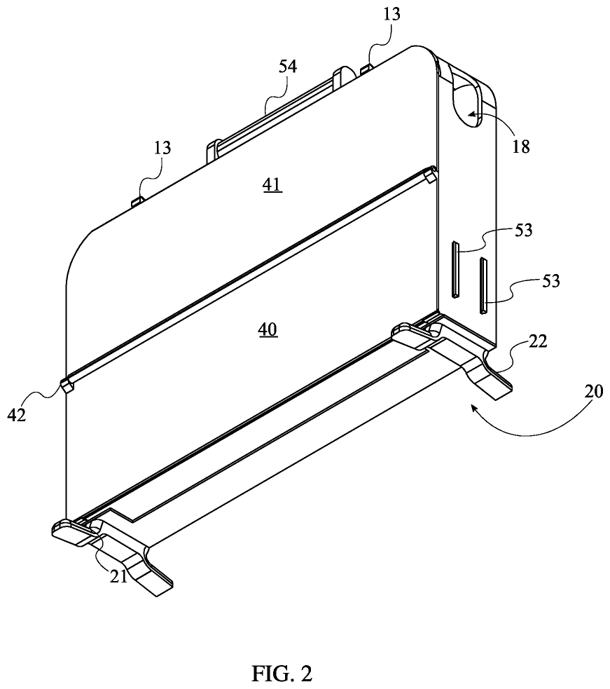

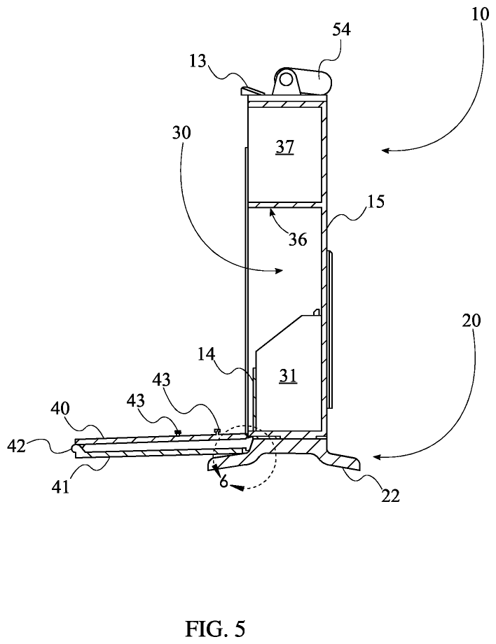

The modular storage case is a reconfigurable portable container suitable to transport tools and materials to a jobsite and provide for the organization of said tools and materials on-site once deployed. To accomplish this, the present invention comprises a case body 10, a primary storage compartment 30, a first panel 40, a second panel 41, an offset hinge 42, at least one latch 13, and a base 20. The case body 10 defines a substantially rigid, impact-resistant superstructure that defines the outer protective layer of the present invention. In reference to FIG. 1, the primary storage compartment 30 traverses normally into the case body 10, defining a structured concavity wherein various items may be stowed for transport. A first lengthwise edge 11 of the case body 10 being positioned opposite to a second lengthwise edge 12 of the case body 10, across the case body 10. The first lengthwise edge 11 defines a reinforced perimeter of the primary storage compartment 30 suitable to support the weight of the first panel 40 and the second panel 41 in a deployed configuration. The second lengthwise edge defines a similar structure to the first lengthwise edge 11, wherein the second lengthwise edge 12 is reinforced to support the weight of first panel 40 and the second panel 41 in a closed configuration. The first panel 40 is hingedly fixed to a first lengthwise edge 11 of the case body 10, whereby the first panel 40 will partially enclose the primary storage compartment 30 when laid flush with the case body 10. The offset hinge 42 is connected between the first panel 40 and the second panel 41. The latch 13 is laterally mounted to the case body 10. Additionally, the latch 13 is positioned adjacent to the second lengthwise edge 12 opposite the first lengthwise edge 11 across the primary storage compartment 30. Thus positioned, the second panel 41 is configured to fix to the second lengthwise edge 12 by at least one latch 13. In reference to FIG. 2, the latch 13 provides a releasable fixture suitable for configuring the present invention into a locked position for transport, wherein the primary storage compartment 30 is substantially or wholly enclosed by the first panel 40 and the second panel 41 in combination with the first panel 40 and the second panel 41 laid flush to the case body 10. Further, the base is laterally mounted to the case body 10. Thus, a stable platform is provided on which the present invention may rest while being configured for deployment. In reference to FIG. 5, the base 20 is positioned adjacent to the first lengthwise edge 11. Consequently, the base 20 does not obstruct the range of motion of the first panel 40 hingedly mounted thereon. In the deployed configuration the second panel 41 is disengaged from the latch 13 and fixed to the base 20, whereby the offset hinge 42 will permit the cross-planar rotation of the second panel 41 relative to the first panel 40 without binding to the first panel 40. The engagement of the second panel 41 to the base will support the first panel 40 in a generally perpendicular relation to the case body 10 in a cantilever configuration. It is specifically contemplated that the cantilever configuration will simultaneously provide access to the primary storage compartment 30 and enable the use of the first panel 40 as a dedicated workspace.

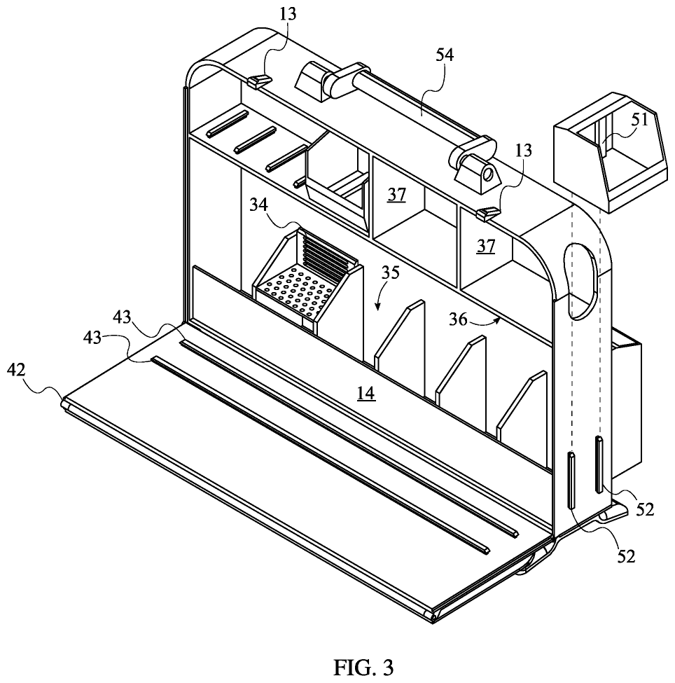

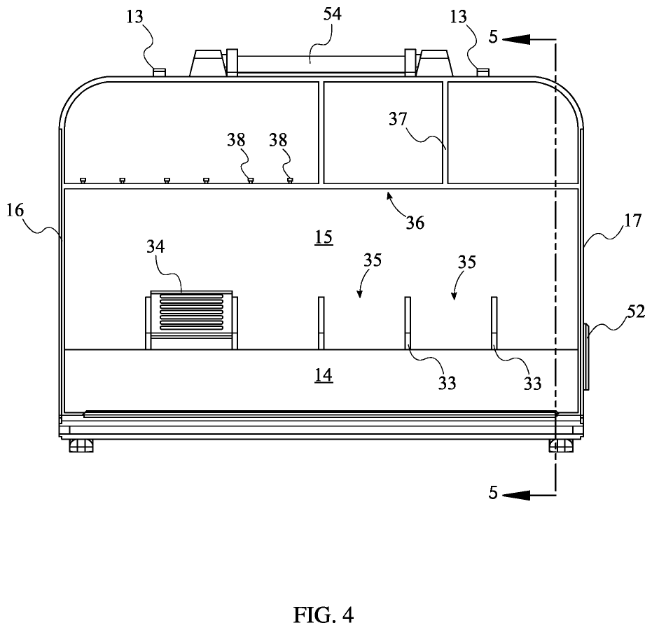

In reference to FIGS. 1 and 4, the present invention further comprises a faceplate 14, a plurality of partitions 31, and a plurality of sub-compartments 32. The faceplate 14 defines an inset structure mounted over a portion of the primary storage compartment 30, adjacent to the first lengthwise edge 11. Accordingly, the face plate provides both a backstop for the first panel 40 in the closed configuration, but also partially delineates the plurality of sub-compartments 32. The plurality of partitions 31 is connected between the faceplate 14 and a back panel 15 of the case body 10. More specifically, the plurality of partitions 31 is distributed laterally along the faceplate 14. Each of the plurality of sub-compartments 32 is delineated by the back panel 15, the face plate 14, and a corresponding pair of partitions 33 from the plurality of partitions 31. Each of the plurality of partitions 31 defines a rigid separator structure for each of the plurality of sub-compartments 32, thereby separating said components into separate and distinct storage areas. It is further contemplated that the plurality of partitions 31 may be irregularly dispersed along the faceplate 14, providing storage areas or differing dimensions for various items. In reference to FIG. 3, the present invention may comprise at least one tool holder 34, wherein the tool holder 34 is mounted within an arbitrary compartment 35 from the plurality of sub-compartments 32. The tool holder 34 is specifically contemplated to be suitable for retaining a number of nails or similar fasteners within the arbitrary compartment 35 but may also be configured to support larger tools and accessories in various alternate embodiments.

In reference to FIG. 4, the present invention further comprises at least one shelf 36 and at least one divider wall 37. The shelf 36 defines a combined internal reinforcement structure and storage area positioned within the primary storage compartment 30. The shelf 36 is mounted offset from the second lengthwise edge 12 across and to the back panel 15 and is connected between a first lateral sidewall 16 and a second lateral sidewall 17 of the case body 10. The shelf provides a storage location for cargo within the primary storage compartment while simultaneously lending structural rigidity to the case body by truncating the longest unsupported spans of the first lateral sidewall 16 and the second lateral sidewall 17. The first lateral sidewall 16 and the second lateral sidewall 17 define interior surfaces of the case body 10 and are offset across the primary storage compartment 30 from each other. The divider wall 37 is connected between the shelf 36 and the second lengthwise edge 12, further subdividing the shelf 36 into additional storage areas for various items. Like the plurality of partitions 31 and the faceplate 14, the divider wall 37 may divide the shelf 36 at irregular intervals to provide suitable storage areas for a variety of items as may be commonly used by tradesmen.

Additionally, the present invention further comprises a plurality of drawer rails 38, a plurality of interior rails 43, and a plurality of exterior rails 53. The plurality of drawer rails 38 are adjacently mounted to the shelf 36 and traverses the shelf 36 perpendicular to the back panel 15. The arrangement of the plurality of drawer rails 38 will enable a user to store and withdraw at least one accessory compartment 50 on the shelf 36 similar to conventional drawers in larger furniture. Further, the plurality of exterior rails 53 is laterally mounted onto the case body 10 to provide mounting positions for additional instances of at least one accessory compartment 50 to be attached for additional storage capacity. Likewise, a plurality of interior rails 43 is mounted adjacent to the first panel 40 between the first panel 40 and the primary storage compartment 30 to further expand the potential mounting locations for additional instances of the accessory compartment 50. It is specifically contemplated that the present invention comprises at least one accessory compartment 50 and at least one rail attachment system 51 in all configurations, whereby the accessory compartment 50 may be configured to mount to the plurality of drawer rails 38, the plurality of exterior rails 53, and the plurality of interior rails 43 via the rail attachment system 51. In various potential configurations the rail attachment system 51 is connected between an arbitrary rail 52 and the accessory compartment 50, wherein the arbitrary rail 52 is from the plurality of exterior rails 53. In one configuration, the accessory compartment 50 may be horizontally mounted to the plurality of drawer rails 38 within the primary storage compartment 30, enabling the unitized storage and transport of separate groups of cargo. In the deployed configuration, the accessory compartment 50 may be mounted vertically to the exterior rails 53, providing unfettered access to the contents of said accessory compartment 50. The rail attachment system 51 is contemplated to provide for a total means of attachment to the arbitrary rail 52 in any position, serving as a universal attachment mechanism compatible with the present invention in general.

In reference to FIG. 3, the present invention is further contemplated to comprise at least one access port 18, wherein the access port 18 laterally traverses through the case body 10 not the primary storage compartment 30. The access port 18 defines any type of permeable opening enabling a user to access items within the primary storage compartment 30 with the present invention in a closed configuration. The capacity to retrieve hand tools or continuously linked materials such as bags, tape, rope, or other small items without requiring the first panel 40 or the second panel 41 to be opened will enhance the utility of the present invention to mobile tradesmen. The access port 18 may further define a sealable portal such that, in conjunction with the latch 13, access to the primary storage compartment 30 may be restricted. The present invention further comprises at least one handle 54 laterally mounted to the case body 10. Thus positioned, the handle 54 defines a grasping point that may be folded or collapsed to the case body 10 when not in use. Thereby, preventing the handle 54 from becoming a snag-point on a worksite. It is further considered that the handle 54 may telescope into the case body 10, base 20, or both to provide maximum adjustability to suit various use-cases.

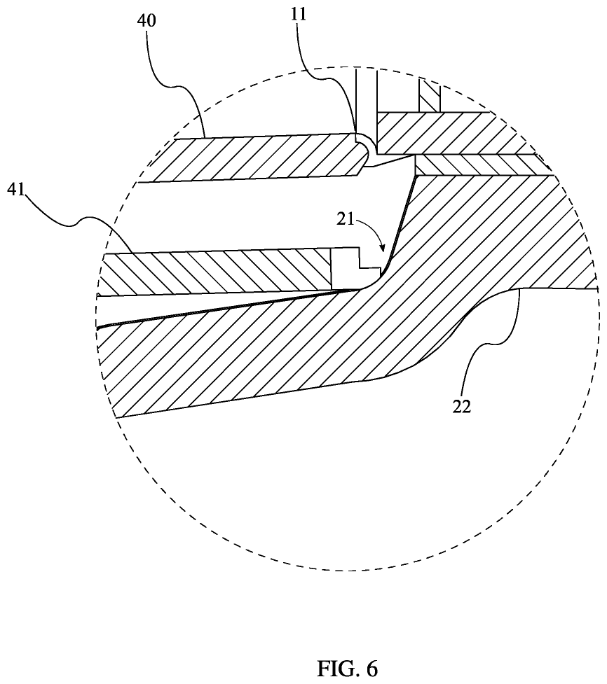

In reference to FIGS. 2 and 6, the base 20 further comprises a catch 21 and a support structure 22, the catch 21 is integrated into the support structure 22 along the first lengthwise edge 11 and the support structure 22 protrudes outward from the case body 10. The support structure 22 defines a laterally flared substructure linked to the case body 10 including specific consideration given to the provision of support to the case body 10 in the deployed configuration, wherein the cantilever formation of the first panel 40 and the second panel 41 may cause the present invention to tip without absent sufficient lateral support or material weight to counterbalance off-center loads. The catch 21 defines a concave portion of the support structure 22 of suitable dimensions to capture the second panel in the cantilever configuration. The cantilever configuration will define an arrangement of the second panel 41 being engaged to the catch 21, wherein the catch 21 limits the motion of the second panel 41 relative to the base 20. This configuration will enable the second panel 41 to be a diagonal support to the first panel 40 linked at the offset hinge 42, providing a working space for the arrangement of any tools, cargo, accessory compartments 50, or other items as may be commonly encountered in an active worksite.

Although the invention has been explained in relation to its preferred embodiment, it is to be understood that many other possible modifications and variations can be made without departing from the spirit and scope of the invention as hereinafter claimed.

What is claimed is:

1. A modular storage case comprising:
a case body;
a primary storage compartment;
a first panel;
a second panel;
an offset hinge;
at least one latch;
a base;
the primary storage compartment traversing into the case body;
a first lengthwise edge of the case body being positioned opposite to a second lengthwise edge of the case body, across the case body;
the first panel being hingedly connected along the first lengthwise edge;
the offset hinge being connected in between the first panel and the second panel;
the latch being laterally mounted onto the case body;
the latch being positioned adjacent to the second lengthwise edge;
the base being laterally mounted onto the case body; and
the base being positioned adjacent to the first lengthwise edge.

2. A modular storage case as claimed in claim 1 comprising:
a faceplate;
a plurality of partitions;
a plurality of sub-compartments;
the faceplate being mounted over a portion of the primary storage compartment;
the faceplate being positioned adjacent to the first lengthwise edge;
the plurality of partitions being connected in between the faceplate and a back panel of the case body;
the plurality of partitions being distributed along the faceplate; and
each of the plurality of sub-compartments being delineated by the back panel, the face plate, and a corresponding pair of partitions, wherein the corresponding pair of partitions is from the plurality of partitions.

3. A modular storage case as claimed in claim 2 comprising:
at least one tool holder; and
the tool holder being mounted within an arbitrary compartment from the plurality of sub-compartments.

4. A modular storage case as claimed in claim 1 comprising:
at least one shelf;
at least one divider wall;
the shelf being mounted onto the back panel;
the shelf being positioned within the primary storage compartment;
the shelf being positioned offset from the second lengthwise edge across the back panel;
the shelf being connected in between a first lateral sidewall of the case body and a second lateral sidewall of the case body; and
the divider wall being connected in between the shelf and the second lengthwise edge.

5. A modular storage case as claimed in claim 4 comprising:
a plurality of drawer rails;
the plurality of drawer rails being adjacently mounted onto the shelf; and
the plurality of drawer rails traversing the shelf perpendicular to the back panel.

6. A modular storage case as claimed in claim 1 comprising:
a plurality of interior rails;
the plurality of interior rails being mounted adjacent to the first panel; and
the plurality of interior rails being positioned in between the first panel and the primary storage compartment.

7. A modular storage case as claimed in claim 1 comprising:
a plurality of exterior rails; and
the plurality of exterior rails being laterally mounted onto the case body.

8. A modular storage case as claimed in claim 7 comprising:
at least one accessory compartment;
at least one rail attachment system; and
the rail attachment system being connected in between an arbitrary rail and the accessory compartment, wherein the arbitrary rail is from the plurality of exterior rails.

9. A modular storage case as claimed in claim 1 comprising:
at least one access port; and
the access port laterally traversing through the case body into the primary storage compartment.

10. A modular storage case as claimed in claim 1 comprising:
at least one handle; and
the handle being laterally mounted onto the case body.

11. A modular storage case as claimed in claim 1 comprising:
the base comprising a catch and a support structure;
the catch being integrated into the support structure along the first lengthwise edge; and
the support structure protruding outward from the case body.

12. A modular storage case comprising:
a case body;
a primary storage compartment;
a first panel;
a second panel;
an offset hinge;
at least one latch;
a base;
a faceplate;
a plurality of partitions;
a plurality of sub-compartments;
the primary storage compartment traversing into the case body;
a first lengthwise edge of the case body being positioned opposite to a second lengthwise edge of the case body, across the case body;
the first panel being hingedly connected along the first lengthwise edge;
the offset hinge being connected in between the first panel and the second panel;
the latch being laterally mounted onto the case body;
the latch being positioned adjacent to the second lengthwise edge;
the base being laterally mounted onto the case body;
the base being positioned adjacent to the first lengthwise edge;
the faceplate being mounted over a portion of the primary storage compartment;
the faceplate being positioned adjacent to the first lengthwise edge;
the plurality of partitions being connected in between the faceplate and a back panel of the case body;
the plurality of partitions being distributed along the faceplate; and
each of the plurality of sub-compartments being delineated by the back panel, the face plate, and a corresponding pair of partitions, wherein the corresponding pair of partitions is from the plurality of partitions.

13. A modular storage case as claimed in claim 12 comprising:
at least one tool holder; and
the tool holder being mounted within an arbitrary compartment from the plurality of sub-compartments.

14. A modular storage case as claimed in claim 12 comprising:
at least one shelf;
at least one divider wall;
the shelf being mounted onto the back panel;
a plurality of drawer rails;
the shelf being positioned within the primary storage compartment;
the shelf being positioned offset from the second lengthwise edge across the back panel;
the shelf being connected in between a first lateral sidewall of the case body and a second lateral sidewall of the case body; and
the divider wall being connected in between the shelf and the second lengthwise edge,
the plurality of drawer rails being adjacently mounted onto the shelf; and
the plurality of drawer rails traversing the shelf perpendicular to the back panel.

15. A modular storage case as claimed in claim 12 comprising:
a plurality of interior rails;
a plurality of exterior rails;
the plurality of interior rails being mounted adjacent to the first panel;
the plurality of interior rails being positioned in between the first panel and the primary storage compartment; and
the plurality of exterior rails being laterally mounted onto the case body.

16. A modular storage case as claimed in claim 15 comprising:
at least one accessory compartment;
at least one rail attachment system; and
the rail attachment system being connected in between an arbitrary rail and the accessory compartment, wherein the arbitrary rail is from the plurality of exterior rails.

17. A modular storage case as claimed in claim 12 comprising:
at least one access port; and
the access port laterally traversing through the case body into the primary storage compartment.

18. A modular storage case as claimed in claim 12 comprising:
at least one handle; and
the handle being laterally mounted onto the case body.

19. A modular storage case as claimed in claim 12 comprising:
the base comprising a catch and a support structure;
the catch being integrated into the support structure along the first lengthwise edge; and
the support structure protruding outward from the case body.
